(19) United States
(12) Patent Application Publication
(10) Pub. No.: US 2013/0316569 A1
(43) Pub. Date: Nov. 28, 2013

(54) Dust-Proof Plug for Mobile Phone

(71) Applicant: Dickson Leung, Shanghai (CN)

(72) Inventor: Dickson Leung, Shanghai (CN)

(73) Assignee: LEO CREATIVE (SHANGHAI) COMPANY LTD., Shanghai (CN)

(21) Appl. No.: 13/565,889

(22) Filed: Aug. 3, 2012

(30) Foreign Application Priority Data
May 22, 2012 (CN) 201210161767.3

(51) Int. Cl. H01R 13/52

(52) U.S. Cl. 439/519

(57) ABSTRACT

The present invention discloses a dust-proof plug for mobile phone, which includes an ornament and a plastic sheath. In detail, an alloy contact pin is fixedly provided on the ornament; a groove is provided on the sidewall of the alloy contact pin; a socket adapted to the alloy contact pin is provided in the plastic sheath; wherein the alloy contact pin is bonded and fixed by gluing after being inserted into the socket. According to the present invention, the solidified glue forms a clamping jaw in the groove to clamp the alloy contact pin. Thus the reliability of connection between the ornament and the plastic sheath is ensured, and this ensures that the ornament may not be loosened or detached from the plastic sheath while in use.

The present invention discloses a dust-proof plug for mobile phone, which includes an ornament and a plastic sheath. In detail, an alloy contact pin is fixedly provided on the ornament; a groove is provided on the sidewall of the alloy contact pin; a socket adapted to the alloy contact pin is provided in the plastic sheath; wherein the alloy contact pin is bonded and fixed by gluing after being inserted into the socket. According to the present invention, the solidified glue forms a clamping jaw in the groove to clamp the alloy contact pin. Thus the reliability of connection between the ornament and the plastic sheath is ensured, and this ensures that the ornament may not be loosened or detached from the plastic sheath while in use.

### TECHNICAL FIELD

The present invention relates to a dust-proof plug for mobile phone and especially to a dust-proof plug which is applied to the socket portion of the external headset of mobile phone.

### BACKGROUND

Mobile phone is one of the most important marks in the modern society, it is extremely popular now, and even everyone in the city has at least one mobile phone. Thus, the personalization of the mobile phone gradually becomes a goal for people to pursue, and therefore various accessories for mobile phone emerge at the right time, wherein the dust-proof accessory for mobile phone is one of them. Considered that headset for mobile phone is not used very often, dust will be accumulated at the groove portion of the headset plug due to exposure in air, and thus influences the performance of mobile phone. Therefore, a dust-proof plug for mobile phone is provided in the market, which not only is water-proof and dust-proof but also serves as ornaments. However, the conventional dust-proof plug for mobile phone is more emphasized for the appearance design. In the aspect of connection structure, the decorative portion is usually directly bonded to the plastic plug portion by glue. As the contact surface also the bonging surface between the decorative portion and the plastic plug is small, the structure of this design is not reliable. The phenomenon, that the decorative portion is detached from the dust-proof portion, i.e. the plastic plug, happens in short time after the plug is used; even the phenomenon, that the plastic plug detached falls into the headset socket and can not be pulled out, happens often.

### SUMMARY

To overcome the defects of the related art, the present invention provides a dust-proof plug for mobile phone with a simple and reasonable structure and high connecting reliability.

The technical solutions adopted to solve the technical problems by the present invention are:

A dust-proof plug for mobile phone includes an ornament and a plastic sheath. An alloy contact pin is fixedly provided on the ornament. A groove is provided on the sidewall of the alloy contact pin. A socket adapted to the alloy contact pin is provided on the plastic sheath. The alloy contact pin is bonded and fixed in the socket by gluing after being inserted into the socket.

As an improvement of the above-mentioned technical solution, the socket is a tapered socket, the diameter of the upper port of the socket is equal to the diameter of cross section in the portion of the alloy contact pin corresponding to the upper port of the socket, the diameter of the lower port is 0.1˜0.3 mm smaller than the diameter of the upper port.

As a further improvement of the above-mentioned technical solution, the alloy contact pin is divided into an upper portion and a lower portion by the groove, the diameter of cross section of the lower portion is 0.1˜0.3 mm larger than the diameter of cross section of the upper portion.

Further, the bottom end of the alloy contact pin is a needle tip.

Further, the groove is 2.0˜2.4 mm distant from the bottom end of the alloy contact pin.

Further, the width of the groove is 1 mm.

The beneficial effects of the present invention are:

As in the present invention, an alloy contact pin is fixedly provided on an ornament; a groove is provided on the sidewall of the alloy contact pin, the alloy contact pin is bonded and fixed by gluing in the socket after being inserted into the socket. The affinity between the glue and the plastic sheath is better than the affinity between the glue and the alloy contact pin, thus the solidified glue forms a clamping jaw in the groove to clamp and lock the alloy contact pin. Compared to the connection structure in the prior art, the contact surface as well as the bonding surface between the ornament and the plastic sheath are significantly increased, so that the bonding effect becomes better. Thus the reliability of connection between the ornament and the plastic sheath is ensured, and this ensures that the ornament may not be loosened or detached from the plastic sheath when in use. Thereby, the phenomenon that the corresponding plastic sheath detached falls into the headset socket of mobile phone and cannot be pulled out is eliminated, and thus higher reliability and safety are provided.

### BRIEF DESCRIPTION OF THE DRAWINGS

Further descriptions of the invention will be made below in conjunction with the accompanying drawings and the embodiments, wherein:

FIG. 1 is a schematic diagram of the structure of the alloy contact pin in the present invention;

FIG. 2 is a full-sectional view of the plastic sheath in the present invention; and

FIG. 3 is a schematic diagram of the assembly of the present invention.

### EMBODIMENTS

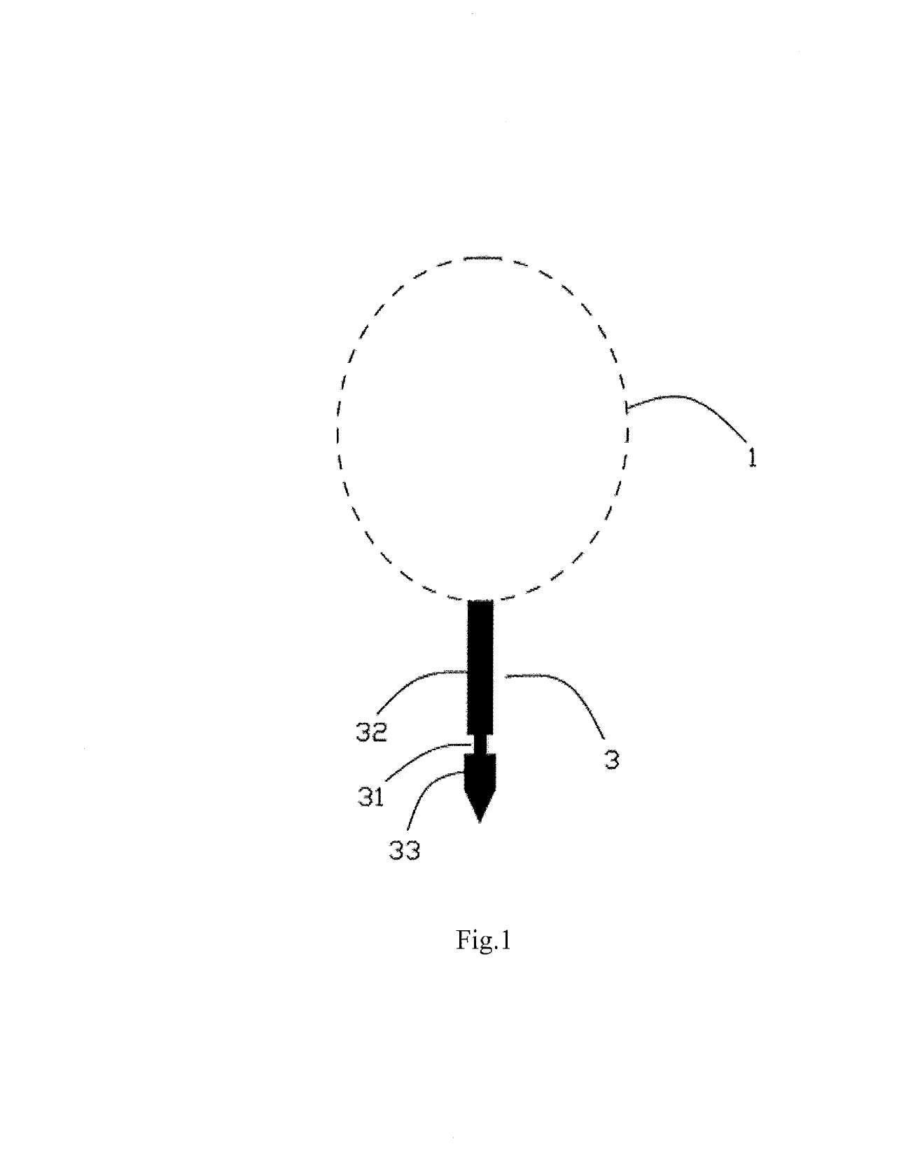

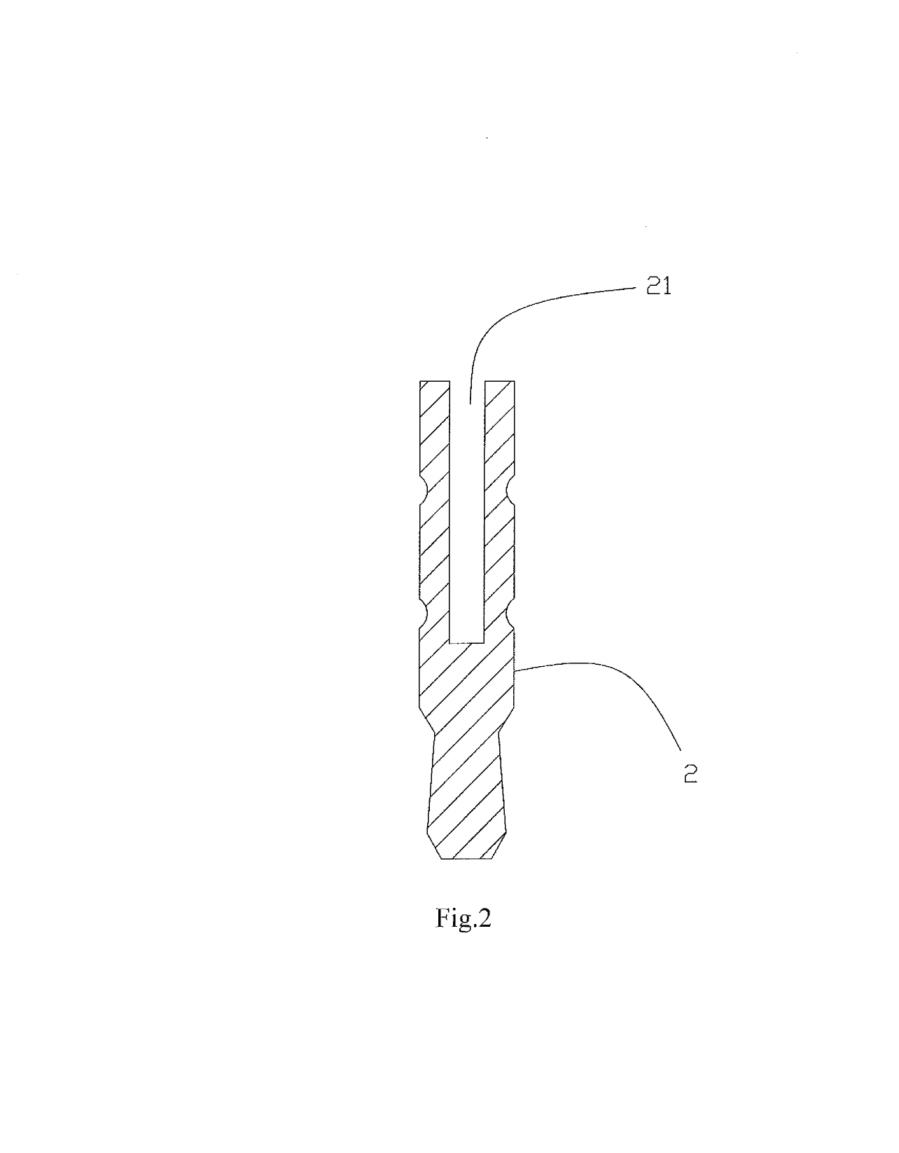

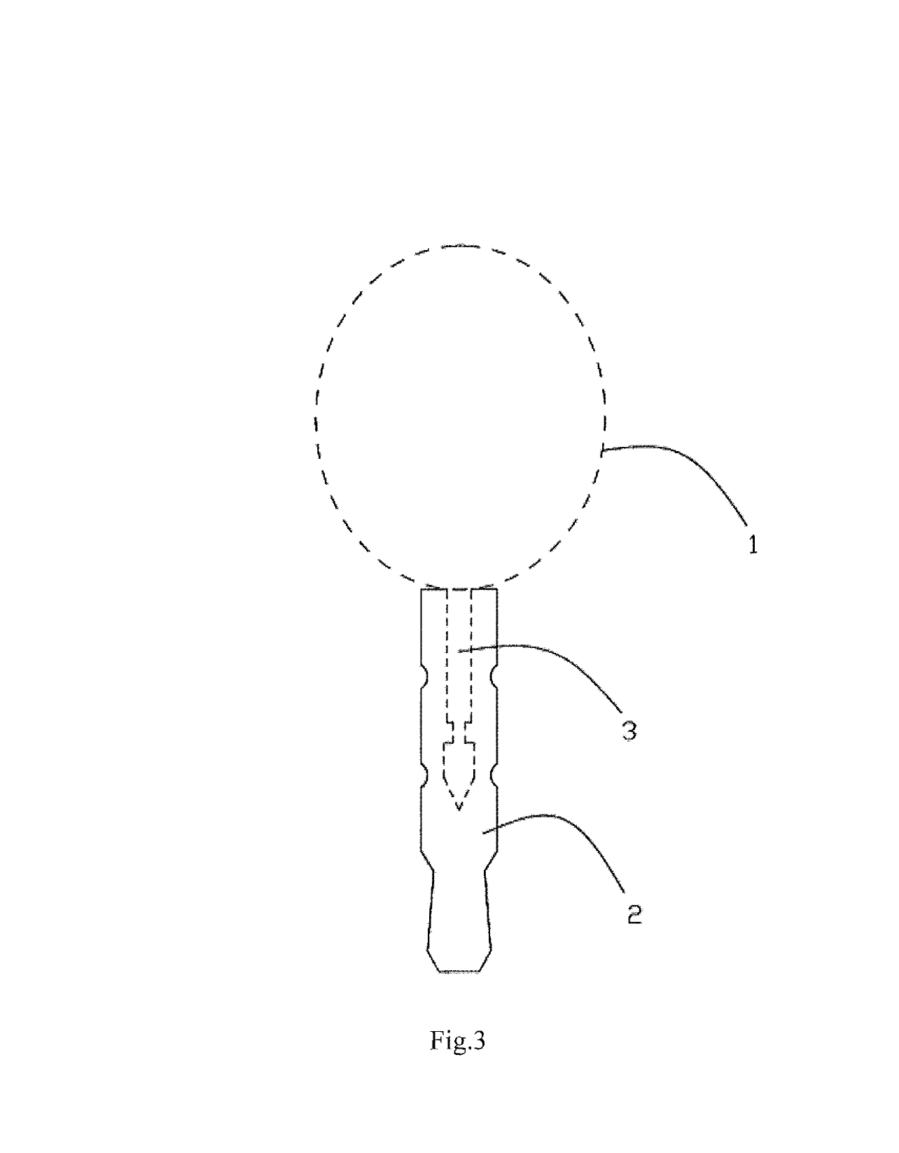

Referring to FIG. 1 to FIG. 3, a dust-proof plug for mobile phone according to the present invention includes an ornament 1, a plastic sheath 2, and an alloy contact pin 3, wherein, the plastic sheath 2 may be made of POM plastic, the alloy contact pin 3 is fixed on the ornament 1, and made of alloy materials. The length of the alloy contact pin 3 is generally ranged from 6 to 10 mm. A groove 31 is formed circumferentially along the sidewall of the alloy contact pin 3. The groove 31 is preferably 2.0˜2.4 mm distant from the bottom end of the alloy contact pin 3. The width of the groove 31 is preferably 1 mm. A socket 21 adapted to the alloy contact pin 3 is provided in the plastic sheath 2, that is, the diameter of cross section of the alloy contact pin 3 may be equal to the diameter of the socket 21. In this case, the diameter of cross section of the alloy contact pin 3 may be preferably 1.15 mm, according to the actual size of the headset socket of mobile phone. Accordingly, the diameter of the socket 21 could be 1.15 mm. The alloy contact pin 3 is bonded and fixed in the socket by gluing after being inserted into the socket 21.

When being assembled, firstly the glue is applied onto the entire alloy contact pin 3, and then the alloy contact pin 3 is aligned to and pushed by a push force into the socket 21. In order to facilitate the insertion, the bottom end of the alloy contact pin 3 is configured as a needle tip. The alloy contact pin 3 is pushed into the socket 21 slowly. After the alloy contact pin 3 is completely inserted into the socket 21, as the alloy contact pin 3 is adapted to the socket 21, the glue solidifies and bonds the alloy contact pin 3 and the plastic sheath 2 together tightly.

Meanwhile, because the affinity between the glue and the plastic sheath 2 is better than it between the glue and the alloy contact pin 3, after the glue is solidified, the glue in the groove 31 may become two clamping jaws of the plastic sheath 2 protruding into and locking the alloy contact pin 3, so that the alloy contact pin 3 cannot easily slide out from the socket 21. In addition, since the plastic sheath 2 is made of plastic materials and has some elasticity, the alloy contact pin 3 and the socket 21 come into close contact with each other after the alloy contact pin 3 is inserted into the socket 21. When the alloy contact pin 3 trends to move, the plastic sheath 2 creates fiction stopping the alloy contact pin 3 from moving, thus it is further ensured that the alloy contact pin 3 may not be pulled out from the socket 21 easily. Compared to the prior art, in which the ornament 1 is directly glued and bonded on a plastic plug, the structure consisted of the groove 31 and the socket 21 according to the present invention allows that the alloy contact pin 3 is clamped tightly by the solidified glue in the socket 21 and more particularly in the groove 31, after the glue is solidified. Meanwhile, the glue bonding surface between the alloy contact pin 3 and the socket 21 is significantly increased, thus the connecting stability between the ornament 1 and the plastic sheath 2 is greatly increased, and this ensures that the ornament 1 may not be loosened or detached from the plastic sheath 2 while in use. Thereby the phenomenon that the corresponding plastic sheath 2 detached falls into the headset socket of mobile phone and cannot be pulled out is eliminated, and higher reliability and safety are provided.

As an improvement of the above-mentioned embodiment, the socket 21 is a tapered socket. The diameter of the upper port of the socket 21 is equal to the diameter of cross section of the alloy contact pin 3 in the portion corresponding to the upper port of the socket 21, and the diameter of the lower port of the socket 21 is 0.1˜0.3 mm smaller than the diameter of its upper port. The diameter of the upper port of the socket 21 may be preferably 1.15 mm, and the diameter of the lower port may be preferably 0.95 mm. Because the socket 21 is configured as a tapered socket, the socket 21 is connected with the alloy contact pin 3 by interference fit. Therefore, the clamping between the socket 21 and the alloy contact pin 3 is more tightened, it is more difficult to pull the alloy contact pin 3 out from the socket 21, and the reliability of connection between the ornament 1 and the plastic sheath 2 is further improved.

Again as a further improvement of the above-mentioned embodiment, the alloy contact pin 3 is divided into an upper portion 32 and a lower portion 33 by the groove 31. The diameter of cross section of the lower portion 33 is 0.1˜0.3 mm larger than the diameter of cross section of the upper portion 32. The upper portion 32 is the portion of the alloy contact pin located at the position above the groove 31, and the lower portion 33 is the portion of the alloy contact pin located at the position below the groove 31. The upper portion 32 is connected with the lower portion 33 through the groove 31. In order to allow the alloy contact pin 3 to be connected with the socket 21 by interference fit, the socket 21 may be configured as a tapered socket, and additionally, the diameter of cross section of the lower portion 33 of the alloy contact pin 3 may also be set to be 0.1˜0.3 mm larger than the diameter of cross section of the upper portion 32. For example, the diameter of cross section of the upper portion 32 may be set to 1.15 mm, and the diameter of cross section of the lower portion 33 may be set to 1.35 mm.

Certainly, when the diameter of cross section of the lower portion 33 of the alloy contact pin 3 is set to be larger than the diameter of cross section of the upper portion 32, the socket 21 may be configured as a tapered socket, so that the clamping force between the alloy contact pin 3 and the socket 21 becomes greater, and the alloy contact pin 3 can be more firmly fixed in the socket 21, thus the ornament 1 is not easily loosened and detached from the plastic sheath 2.

The above-mentioned descriptions are only the preferred embodiments of the present invention, and the present invention should not be limited to the above-mentioned embodiments, as long as the technical effects can be achieved by the same or alike means, which should also fall within the protection scope of the present invention.

1. A dust-proof plug for mobile phone, comprising an ornament and a plastic sheath, characterized in that: the plug further comprises a alloy contact pin, which is fixed on the ornament, and provided with a groove on the sidewall thereof, accordingly the plastic sheath is provided with a socket adapted to the alloy contact pin therein, wherein the alloy contact pin is bonded and fixed in the socket by gluing after being inserted into the socket.

2. The dust-proof plug for mobile phone according to claim 1, characterized in that: the socket is a tapered socket, the diameter of the upper port of the socket is equal to the diameter of cross section of the alloy contact pin in the portion corresponding to the upper port of the socket, the diameter of the lower port is approximately 0.1 to 0.3 mm smaller than the diameter of the upper port.

3. The dust-proof plug for mobile phone according to claim 1, characterized in that: the alloy contact pin is divided into an upper portion and a lower portion by the groove, and the diameter of cross section of the lower portion is approximately 0.1 to 0.3 mm larger than the diameter of cross section of the upper portion.

4. The dust-proof plug for mobile phone according to claim 3, characterized in that: the bottom end of the alloy contact pin is a needle tip.

5. The dust-proof plug for mobile phone according to claim 3, characterized in that: the groove is approximately 2.0 to 2.4 mm distant from the bottom end of the alloy contact pin.

6. The dust-proof plug for mobile phone according to claim 3, characterized in that: the width of the groove is 1 mm.
